(19) United States
(12) Patent Application Publication
(10) Pub. No.: US 2008/0043216 A1
(43) Pub. Date: Feb. 21, 2008

(54) FILM HOLDER AND FILM SCAN MODULE USING THE SAME AND MULTI-FUNCTIONAL PERIPHERAL USING THE SAME

(75) Inventor: Ying-Qi Zhu, Jiangsu Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taoyuan Shien (TW)

(21) Appl. No.: 11/839,567

(22) Filed: Aug. 16, 2007

(30) Foreign Application Priority Data
Aug. 21, 2006 (TW) 95130714

(51) Int. Cl. G03B 27/58; G03B 17/26

(52) U.S. Cl. 355/72; 396/517

(57) ABSTRACT

A film holder and a film scan module using the same and a multi-functional peripheral using the same are provided. The film holder is used in a multi-functional peripheral for fixing at least a film. The multi-functional peripheral comprises a cap body and a main body assembled thereon. The film holder comprises a board and a clip portion. The board is movably disposed on the undersurface of the cap body. The clip portion is disposed on the board for fixing the film. The film can be disposed on the board that is fixed on the undersurface of the cap body. When the cap body covers the main body, the cap body is against the board for pressing and making the film spread on the main body.

This application claims the benefit of Taiwan application Serial No. 95130714, filed Aug. 21, 2006, the subject matter of which is incorporated herein by reference.

### BACKGROUND OF THE INVENTION

1. Field of the Invention

The invention relates in general to a scanning device, and more particularly to a scanning device having a film holder.

2. Description of the Related Art

Scanners are mainly categorized into a charge coupled device (CCD) scanner that has a CCD module and a contact image sensor (CIS) scanner that has a CIS module. Both the CCD module and the CIS module receive an optical signal and convert that into an electrical signal. The CCD scanner that has a larger depth of field is capable of obtaining a clearer image of 3-D objects, books, magazines or documents. However, because the CIS scanner has a smaller depth of field, it is necessary to spread the document to be scanned closely on the scanning window glass of the CIS scanner, lest the document might be positioned outside the range of the depth of field of the CIS scanner. The CCD module has a larger size; hence the scanning devices using CCD modules are normally bigger and heavier. The CIS module has a smaller size; hence the scanning devices using the CIS modules are normally lighter and thinner. Therefore, normally the CIS module is used in the scanning devices to achieve the object of lightweight, slimness and compactness.

Currently, multi-functional peripherals are capable of scanning documents, photocopying documents, facsimileing documents, and scanning films. Take film scanning function for example. A film is a transparent and small-sized document. Normally, the multi-functional peripheral has a film holder and a scanning light source, such that a user is able to place the film on the film holder, position the film holder on the scanning window glass of the multi-functional peripheral, and then the multi-functional peripheral scans the film with the help of the scanning light source. Normally, the multi-functional peripheral has the CCD module or the CIS module to receive and covert signals. The film holder is usually an accessory of the multi-functional peripheral, it has to be stored up when not in use, and otherwise it is easily misplaced.

Conventionally, the film holder has a frame containing a scan area. The two sides of the frame have a wave-shaped top track and a line-shaped bottom track, and a gap is formed between the top track and the bottom track. When placing a film, the film is loaded through the gap between the top track and the bottom track such that the film corresponds to the scan area. The size of the gap between the top track and the bottom track is already fixed during the manufacturing of the film holder. If the gap is small, the top track and the bottom track can fix the film more firmly but make it difficult to install the film on the film holder. On the contrary, if the gap is large, the film can be easily installed on the film holder but the top track and the bottom track have loose grip for the film, and the film installed on the film holder would easily bend and become uneven, affecting scanning quality.

Moreover, due to the structural factors of the film holder, after the film holder is installed on the scanning window glass of the multi-functional peripheral, the film and the scanning window glass will be aparted by a distance, so the film holder is only applicable to the multi-functional peripheral having CCD module with a larger depth of field. If the film holder is incorporated with a multi-functional peripheral having CIS module with a smaller depth of field, the scanning quality will be affected or even the film holder is not applicable to the multi-functional peripheral.

### SUMMARY OF THE INVENTION

The invention is directed to a film holder and a film scan module using the same and a multi-functional peripheral using the same. The film holder is disposed on the cap body of the multi-functional peripheral for fixing the films with different sizes. As the film holder and the film scan module are disposed between the cap body and the document press element on the multi-functional peripheral, when there is no need to scan films, the document press element covers the film holder and the film scan module and is at a received state. When the document press element slides with respect to the cap body, the film holder and the film scan module are exposed. When the film holder that has fixed the film is disposed on the cap body and the cap body covers the main body of the multi-functional peripheral, the cap body presses the film holder and makes the film spread closely on the scanning window glass of the multi-functional peripheral. It effectively resolves the problem that the film is out of the range of field depth.

According to a first aspect of the present invention, a film holder used in a multi-functional peripheral for fixing at least a film is provided. The multi-functional peripheral includes a cap body and a main body assembled thereon. The film holder includes a board and a clip portion. The board is movably disposed on the undersurface of the cap body, and the clip portion is disposed on the board for fixing the film. The film is disposed on the board and the board is fixed on the undersurface of the cap body. When the cap body covers the main body, the cap body is against the board for pressing and making the film spread on the main body.

According to a second aspect of the present invention, a film scan module used in a multi-functional peripheral for fixing at least a film is provided. The multi-functional peripheral includes a cap body and a main body assembled thereon. The film scan module includes a light source and a film holder. The light source is disposed in the cap body. The film holder includes a board and a clip portion. The board is movably disposed on the undersurface of the cap body and is selectively fixed on the cap body. The clip portion is disposed on the board for fixing the film. The film is disposed on the film holder and the film holder is fixed on the cap body. When the cap body covers the main body, the cap body is against the film holder for pressing and making the film spread on the main body.

According to a third aspect of the present invention, a multi-functional peripheral includes a main body, a cap body and a film scan module is provided. The cap body is movably disposed on the main body. The film scan module is disposed between the main body and the cap body. The film scan module includes a light source and a film holder. The light source is disposed in the cap body for providing a light for scanning a film. The film holder includes a board and a clip portion. The board is movably disposed on the undersurface of the cap body and is selectively fixed on the cap body. The clip portion is disposed on the board for fixing at least a film on the board. The film is disposed on the film holder and the film holder is fixed on the cap body. When the cap body covers the main body, the cap body is against the film holder for pressing and making the film spread on the main body

The invention will become apparent from the following detailed description of the preferred but non-limiting embodiments. The following description is made with reference to the accompanying drawings.

### BRIEF DESCRIPTION OF THE DRAWINGS

FIG. 1A is a perspective of a multi-functional peripheral according to a preferred embodiment of the invention;

FIG. 1B is a partial diagram of the multi-functional peripheral of FIG. 1A;

FIG. 2A is a structural diagram showing the top surface of the film holder of FIG. 1A;

FIG. 2B is a structural diagram showing the bottom surface of the film holder of FIG. 1A;

FIG. 3 is diagram showing the film holder of FIG. 2A fixing one single film;

FIG. 4A is diagram showing the film holder of FIG. 2A fixing multiple continuous films;

FIG. 4B is a sectional view showing the film holder of FIG. 4A in a working state;

FIG. 5 is a perspective showing the film holder of FIG. 4A being fixed on the multi-functional peripheral; and

FIG. 6A is a perspective showing the multi-functional peripheral of FIG. 1A scanning a film; and

FIG. 6B is a partial sectional view of the multi-functional peripheral of FIG. 6A.

### DETAILED DESCRIPTION OF THE INVENTION

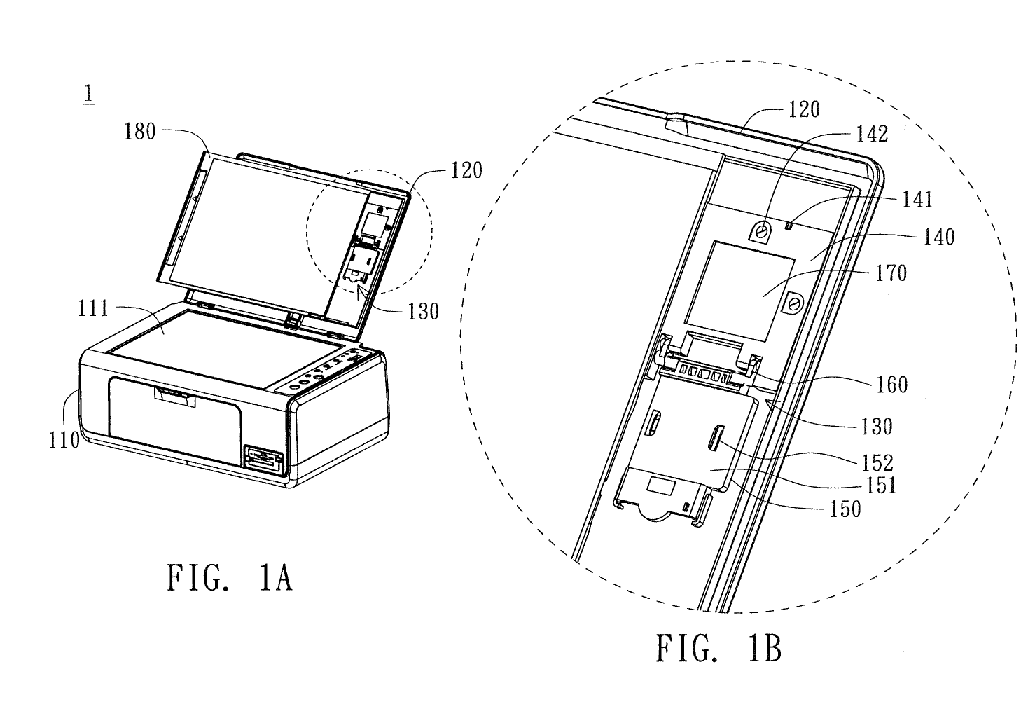

Refer to FIG. 1A˜1B. FIG. 1A is a perspective of a multi-functional peripheral according to a preferred embodiment of the invention. FIG. 1B is a partial diagram of the multi-functional peripheral of FIG. 1A. As indicated in FIG. 1A, the multi-functional peripheral 1 includes a main body 110, a cap body 120 and a film scan module 130. The cap body 120 is movably disposed on the main body 110. The film scan module 130 is disposed on the cap body 120 and positioned between the cap body 120 and the main body 110. As indicated in FIG. 1B, the film scan module 130 includes a carrying base 140, a film holder 150 and a light source 170. The carrying base 140 is fixed on the undersurface of the cap body 120. The light source 170 is disposed in the cap body 120 and positioned under the carrying base 140 for providing a light for scanning a film. The film holder 150 includes a board 151 and a clip portion 152. The board 151 is movably disposed on the carrying base 140 and selectively fixed on the cap body 120. The clip portion 152 is disposed on the board 151 for fixing at least a film on the board 151. The film is disposed on the film holder 150 and the film holder 150 is fixed on the cap body 120. When the cap body 120 covers the main body 110, the cap body 120 is against the film holder 150 for pressing and making the film spread on the main body 110.

As indicated in FIG. 1B, the board 151 of the film holder 150 is preferably rotatably disposed on the carrying base 140 and selectively fixed on the carrying base 140. For example, the film scan module 130 has a hinge 160 whose one end is coupled with the carrying base 140 and the other end is coupled with the film holder 150 such that the film holder 150 can rotate with respect to the carrying base 140. The carrying base 140 has a positioning slot 141 and a magnetizable element 142 for fixing the film holder 150 on the carrying base 140.

Despite the film holder 150 is connected to the carrying base 140 by the hinge 160, in other embodiments, the film holder 150 and the carrying base 140 can be used separately without affecting the function of the film holder 150. The design of assembling the film holder 150 and the carrying base 140 together not only facilitates the storage of the multi-functional peripheral 1, but also prevents the film holder 150 from being misplaced.

The film holder 150 is preferably made from a transparent plastic material such as polycarbonate (PC) or polymethyl methacrylate (PMMA) for permitting the light emitted from the light source 170 to pass through the film holder 150.

Preferably, as indicated in FIG. 1A, the cap body 120 is pivotally connected to one side of the main body 110, such that the cap body 120 can be turned over with respect to the main body 110 to load a to-be-scanned document or film to the film holder 150. The main body 110 has a carrying platform 111 disposed on the top surface of the main body 110 for carrying the to-be-scanned document. Normally, the carrying platform 111 is a scanning window glass. When scanning a document, the scanning light source (not illustrated) disposed in the main body 110 of the multi-functional peripheral 1 projects a light onto the document via the scanning window glass, and the light is reflected to the main body 110 and received by the scanning module (not illustrated) inside the main body 110. Examples of the scanning module include a charge coupled device (CCD) module or a contact image sensor (CIS) module. When scanning a film, the film is fixed on the film holder 150 first, and then the cap body 120 covers the main body 110 such that the film is completely spread on the carrying platform 111.

The multi-functional peripheral 1 further includes a document press element 180. The document press element 180 is disposed on the undersurface of the cap body 120 and is preferably slideable on the cap body 120. The film scan module 130 is also disposed on the undersurface of the cap body 120. Preferably, the film scan module 130 is disposed between the cap body 120 and the document press element 180. That is, the document press element 180 selectively covers or exposes the film scan module 130. For example, when the document press element 180 slides inwardly to the cap body 120 or slides rightward as indicated in FIG. 1A, the document press element 180 covers the film scan module 130. When the document press element 180 slides outwardly from the cap body 120 or slides leftward as indicated in FIG. 1A, the document press element 180 exposes the film scan module 130. When the document press element 180 exposes the film scan module 130, the film holder 150 is capable of being rotated from an initial position to a working position. When in the initial position, the carrying base 140 and the film holder 150 are respectively spread on the undersurface of (referring to FIG. 1B) of the cap body 120. When the film holder 150 is rotated from the initial position to the working position, the film holder 150 is disposed above the carrying base 140.

Preferably, the document press element 180 is a sponge board for pressing the document spread on the carrying platform 111 (the scanning window glass) and providing an interface for blocking the light. The sponge board has elasticity, and is able to completely spread the document on the carrying platform 111.

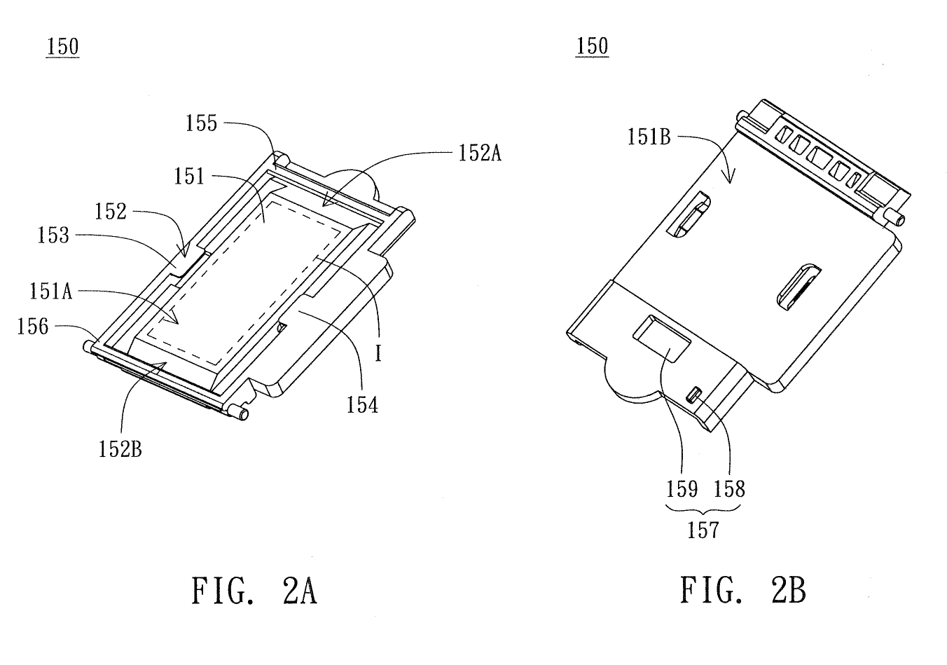

Refer to FIGS. 2A˜2B. FIG. 2A is a structural diagram showing the top surface of the film holder of FIG. 1A. FIG. 2B is a structural diagram showing the bottom surface of the film holder of FIG. 1A, wherein the bottom surface contacts the carrying base 140. As indicated in FIG. 2A, the board 151 has a scan area I, and preferably, the clip portion 152 has a first fixing member and a second fixing member respectively disposed on the board 152 for clamping two sides of the film. The first fixing member and the second fixing member are disposed on two outer sides of the scan area I. When the film is disposed on the film holder 150, the first fixing member and the second fixing member clamp the two sides of the film for fixing the film. It enables the effective scan area of the film to correspond to the scan area I on the board 151. The first fixing member includes a first hook 153 and a second hook 154 both disposed on the top surface 151A of the board 151. The first hook 153 and the second hook 154 are used for clamping a single film. Alternatively, the board 151 can have several first hooks 153 and several second hooks 154 disposed thereon. The present embodiment of the invention is exemplified by a single first hook 153 and a single second hook 154.

The second fixing member includes a first fixing beam 155 and a second fixing beam 156. The two ends of the first fixing beam 155 are respectively connected to two opposite sides of the board 151, and the two ends of the second fixing beam 156 are also respectively connected to two opposite sides of the board 151. Preferably, the first fixing beam 155 and the second fixing beam 156 are disposed on the board 151 in parallel. With the design of the first fixing beam 155 and the second fixing beam 156, the clip portion 152 has a film entrance 152A and a film exit 152B. Before the scanning starts, the film is loaded to the film holder 150 via the film entrance 152A and comes out from the film exit 152B, such that the film is fixed on the board 151. The first fixing beam 155, the second fixing beam 156, film entrance 152A and the film exit 152B are also applicable to fixing multiple continuous films.

In other embodiments, the clip portion can have both the first fixing member and the second fixing member. The first fixing member and the second fixing member can be integrally formed in one piece with the board 151 while the film holder 150 is manufactured.

As indicated in FIG. 2B, the film holder 150 further includes a positioning portion 157. The positioning portion 157 is located on the bottom surface 151B of the board 151 and coupled with the carrying base 140 for fixing the film holder 150 on the carrying base 140. The positioning portion 157 has a bump 158 that is embedded into the positioning slot 141 (referring to FIG. 1B) of the carrying base 140 for fixing the film holder 150 on the carrying base 140. The positioning portion 157 further includes a magnetic element (not illustrated), such as a positioning magnet, disposed in the positioning magnet slot 159 of the film holder 150 for fixing the film holder 150 on the carrying base 140 via the magnetic attraction of the magnetic element and the magnetizable element 142 (referring to FIG. 1B) on the carrying base 140. The magnetizable element 142 can be a jointing element, such as a positioning screw, that is used for fixing the carrying base 140 on the cap body 120. With the magnetic attraction between the magnet and the screw, no additional element is required for fixing the film holder 150, hence simplifying the overall structure.

Apart from the design of fixing the film holder 150 on the carrying base 140 by the bump 158 and the magnetic element 159, any other designs of jointing two elements are also applicable to fixing the film holder 150. For example, the film holder 150 can be fixed by an elastic hook. By connecting one end of the elastic hook to the film holder 150 and the other end of the elastic hook to the carrying base 140 or the cap body 120, the film holder 150 can also be fixed firmly on the carrying base 140.

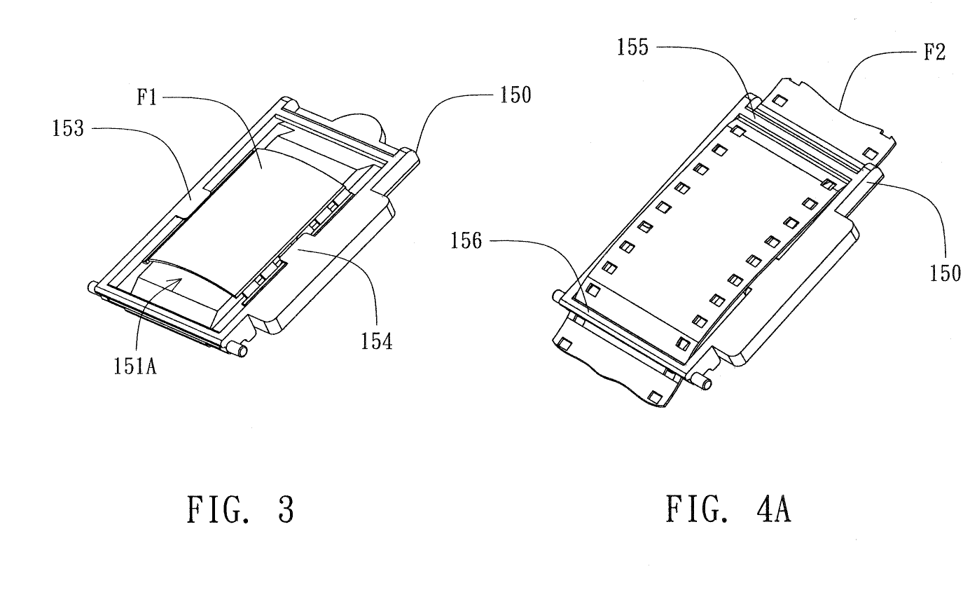

Referring to FIG. 3, a diagram showing the film holder of FIG. 2A fixing one single film is shown. As indicated in FIG. 3, the single film F1 is fixed on the top surface 151A by the first hook 153 and the second hook 154. After the single film F1 is clamped, the single film F1 will hunch up in a natural state instead of completely spreading on the film holder 150.

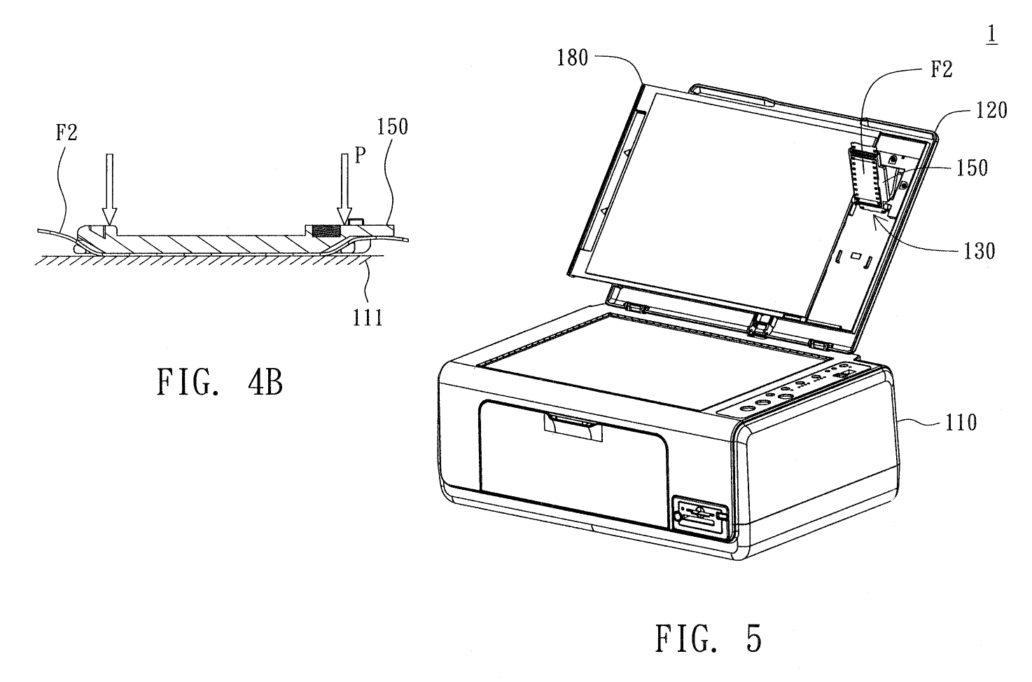

Refer to FIGS. 4A˜4B. FIG. 4A is diagram showing the film holder of FIG. 2A fixing multiple continuous films. FIG. 4B is a sectional view showing the film holder of FIG. 4A in a working state. As indicated in FIG. 4A, using the first fixing beam 155 and the second fixing beam 156 to fix multiple continuous films F2 is preferred. Because the multiple continuous films F2 has a certain level of elasticity and hardness, after being loaded in the film holder 150, it will not be completely spread on the film holder 150 in a natural state, that is, a certain gap exists between the multiple continuous films F2 and the film holder 150. As indicated in FIG. 4B, when the film holder 150 is in the working state, the film holder 150 receives a pressing force P from the cap body 120 for pressing and making the multiple continuous films F2 spread on the carrying platform 111. Likewise, the single film F1 (referring to FIG. 3) is also spread on the carrying platform 111.

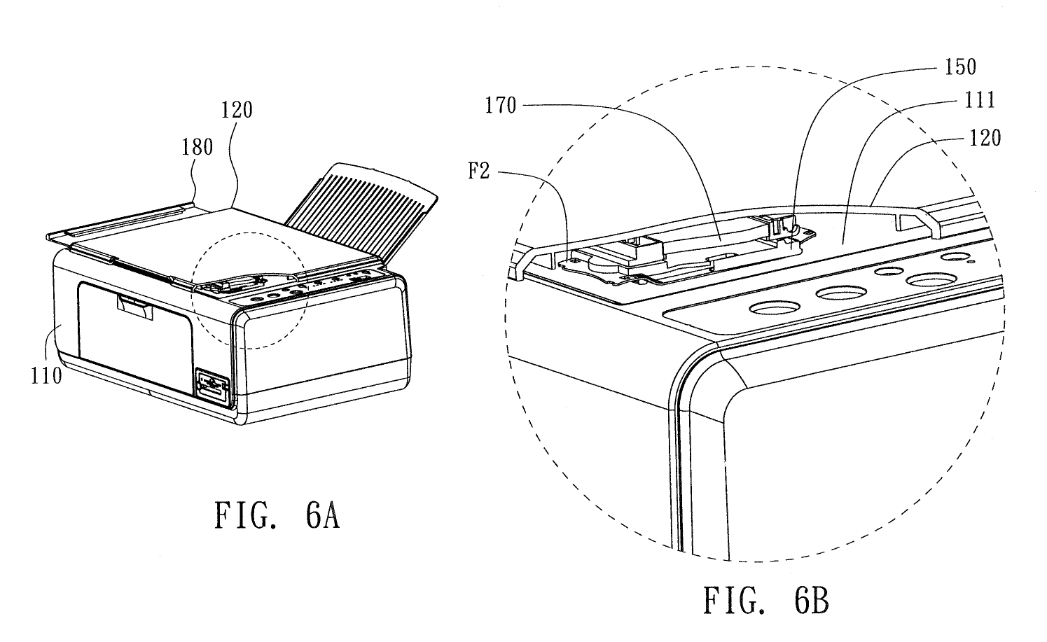

The present embodiment of the invention is exemplified by the multi-functional peripheral while scanning multiple continuous films F2. Refer to FIG. 5 and FIGS. 6A˜6B. FIG. 5 is a perspective showing the film holder of FIG. 4A being fixed on the multi-functional peripheral. FIG. 6A is a perspective showing the multi-functional peripheral of FIG. 1A scanning a film. FIG. 6B is a partial sectional view of the multi-functional peripheral of FIG. 6A. As the document press element 180 exposes the film scan module 130, after the film holder 150 that is fixed on the cap body 120 is turned over from the initial position (referring to FIG. 1), the multiple continuous films F2 can be loaded on the film holder 150. Afterwards, the cap body 120 covers the main body 110. Meanwhile, as indicated in FIG. 6A˜6B, a part of the document press element 180 disposed between the main body 110 and the cap body 120 is protruded. The film holder 150 receives the pressing force from the cap body 120 for pressing and making the multiple continuous films F2 spread on the carrying platform 111. During the scanning, the light provided by the light source 170 can precisely get through the film holder 150 and the continuous films F2.

When the multi-functional peripheral 1 is used to scan a film, the design of the film holder 150 and the film scan module 130 effectively enables the film to be totally spread on the carrying platform 111 evenly, such that the film will not be placed outside the range of the field depth due to the gap between the film and the carrying platform 111.

The advantages of the invention are stated below:
(1) The installation of the film is easier. With the design of the first hook and the second hook, it is easier to fix a single film on the film holder; and with the design of the first fixing beam and the second fixing beam, multiple continuous films is also fixed on the film holder more easily.
(2) No matter only one film or multiple continuous films is loaded on the film holder, the film is pressed and spread tighter and more reliable according to the fixing manner of the invention than that of the conventional method that uses a film holder having a frame to press the film.
(3) The film holder is lightweight and slim and the document press element is slideable with respect to the cap body, such that the film scan module can be stored between the document press element and the cap body when not in working state, not only reducing the storage space for the film holder but also preventing the film holder from being misplaced.
(4) When scanning a film, the document press element is pushed to slide a little but not separated from the cap body. The film holder and the carrying base are connected via a hinge, so the film holder can be turned over.

According to the film holder and the film scan module using the same and the multi-functional peripheral using the same disclosed in the above embodiments of the invention, the film holder is disposed on the cap body of the multi-functional peripheral, and the film scan module is disposed between the cap body and the document press. The film holder can fix a single film or multiple continuous films, and further presses and makes the film/films spread evenly on the scanning window glass of the multi-functional peripheral via the cap body and the film holder. Besides, the film holder and the film scan module are disposed on the multi-functional peripheral, there is no need to store the film holder in other place, not only preventing the film holder from being misplaced but also incorporating more functions in one device. Meanwhile, the film holder is made from commonly used materials and can be integrally formed in one piece to reduce the manufacturing cost. The related products using the film holder, the film scan module and the multi-functional peripheral have high market competitiveness.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A film holder used in a multi-functional peripheral for fixing at least a film, wherein the multi-functional peripheral has a main body and a cap body assembled thereon, and the film holder comprises:
a board movably disposed on the undersurface of the cap body; and
a clip portion disposed on the board for fixing the film;
wherein the film is disposed on the board that is fixed on the undersurface of the cap body, when the cap body covers the main body, the cap body is against the board for pressing and making the film spread on the main body.

2. The film holder according to claim 1, wherein the clip portion comprises a first fixing member disposed on the board, the first fixing member has at least a first hook and at least a second hook, and both the first hook and the second hook are disposed on the top surface of the film holder for clamping two sides of the film.

3. The film holder according to claim 1, wherein the clip portion further comprises a second fixing member disposed on the top surface of the board, the second fixing member comprises a first fixing beam and a second fixing beam whose two ends are respectively connected to two opposite sides of the board for clamping the film.

4. The film holder according to claim 1, wherein the clip portion comprises a film entrance and a film exit respectively positioned on two sides of the board, and the film is loaded via the film entrance and penetrates through the film exit to be fixed on the board.

5. The film holder according to claim 1, further comprising:
a positioning portion disposed on the bottom surface of the film holder, wherein the positioning portion is connected with the cap body for fixing the film holder on the cap body.

6. The film holder according to claim 5, wherein the positioning portion comprises a bump, the multi-functional peripheral comprises a positioning slot positioned on the undersurface of the cap body, and the bump is embedded into the positioning slot for fixing the board on the cap body.

7. The film holder according to claim 5, wherein the positioning portion comprises a magnetic element, the multi-functional peripheral comprises a magnetizable element positioned on the undersurface of the cap body, and the film holder is fixed on the cap body via the magnetic attraction of the magnetic element and the magnetizable element.

8. The film holder according to claim 7, wherein the magnetizable element is a positioning screw.

9. A film scan module used in a multi-functional peripheral for fixing at least a film, wherein the multi-functional peripheral has a main body and a cap body assembled thereon, and the film scan module comprises:
the film holder of claim 1; and
a light source disposed in the cap body for providing a light for scanning the film;
wherein the film is disposed on the film holder and the film holder is fixed on the cap body, when the cap body covers the main body, the cap body is against the film holder for pressing and making the film spread on the main body.

10. The film scan module according to claim 9, further comprising a carrying base fixed on the cap body, wherein the film holder is rotatably disposed on the carrying base connected with the cap body, and the light source is disposed under the carrying base.

11. The film scan module according to claim 10, further comprising:
at least a hinge whose one end is coupled to the carrying base and the other end is coupled to the film holder.

12. The film scan module according to claim 10, wherein the film holder further comprises a positioning portion disposed on the bottom surface of the film holder and connected with the carrying base for fixing the film holder on the carrying base.

13. The film scan module according to claim 12, wherein the positioning portion comprises a bump, the carrying base comprises a positioning slot, and the bump is embedded into the positioning slot for fixing the film holder on the carrying base.

14. The film scan module according to claim 12, wherein the positioning portion comprises a magnetic element, the carrying base comprises a magnetizable element, and the film holder is fixed on the carrying base via the magnetic attraction of the magnetic element and the magnetizable element.

15. The film scan module according to claim 14, wherein the magnetizable element is a positioning screw.

16. A multi-functional peripheral, comprising:
a main body and a cap body, wherein the cap body is movably disposed on the main body; and
a film scan module disposed between the main body and the cap body, the film scan module comprising:
a film holder of claim 1; and
a light source disposed in the cap body for providing a light for scanning the film;
wherein the film is disposed on the film holder that is fixed on the cap body, when the cap body covers the main body, the cap body is against the film holder for pressing and making the film spread on the main body.

17. The multi-functional peripheral according to claim 16, wherein the main body has a carrying platform disposed on the top surface of the main body, and when the film is fixed on the film holder and the cap body covers the main body, the film is spread on the carrying platform.

18. The multi-functional peripheral according to claim 17, wherein the carrying platform is a scanning window glass.

19. The multi-functional peripheral according to claim 16, wherein the film holder has a scan area, the film has a film effective scan area, and when the film is fixed on the film holder, the film effective scan area corresponds to the scan area of the film holder.

20. The multi-functional peripheral according to claim 16, further comprising:
a document press element slideably disposed on the cap body and positioned on the undersurface of the cap body, wherein the document press element selectively covers or exposes the film scan module.

21. The multi-functional peripheral according to claim 20, wherein:
when the document press element exposes the film scan module, the film holder rotates to a working position from an initial position.

22. The multi-functional peripheral according to claim 21, wherein:
when the film holder is in the initial position, the film holder is on the undersurface of the cap body;
when the film holder is in the working position, the film holder is positioned above the light source.

23. The multi-functional peripheral according to claim 20, wherein the document press element is a sponge board.

24. The multi-functional peripheral according to claim 16, wherein the film scan module further comprises a carrying base fixed on the cap body, the film holder is rotatably disposed on the carrying base and connected with the cap body, and the light source is disposed under the carrying base.

25. The multi-functional peripheral according to claim 24, wherein the film scan module further comprises a hinge whose one end is coupled to the carrying base and the other end is coupled to the film holder.

26. The multi-functional peripheral according to claim 24, wherein the film holder further comprises a positioning portion disposed on the bottom surface of the film holder and coupled with the carrying base for fixing the film holder on the carrying base.

27. The multi-functional peripheral according to claim 26, wherein the positioning portion comprises a bump, the carrying base comprises a positioning slot, and the bump is embedded into the positioning slot for fixing the film holder on the carrying base.

28. The multi-functional peripheral according to claim 26, wherein the positioning portion comprises a magnetic element, the carrying base comprises a magnetizable element, and the film holder is fixed on the carrying base via a magnetic attraction of the magnetic element and the magnetizable element.

29. The multi-functional peripheral according to claim 28, wherein the magnetizable element is a positioning screw.
